(19) United States
(12) Patent Application Publication
(10) Pub. No.: US 2026/0253933 A1
(43) Pub. Date: Aug. 27, 2026

(54) FUEL CELL STACK ASSEMBLY WITH COMPRESSION MEANS

(71) Applicant: POWERCELL SWEDEN AB, 41 834 Gothenburg (SE)

(72) Inventor: Oskar EKBLAD, Gothenburg (SE)

(73) Assignee: POWERCELL SWEDEN AB, 41 834 Gothenburg (SE)

(21) Appl. No.: 18/994,302

(22) PCT Filed: Jul. 5, 2023
(86) PCT No.: PCT/SE2023/050705

§ 371 Date: Jan. 14, 2025

(30) Foreign Application Priority Data
Aug. 3, 2022 (SE) 2250946-7

(51) Int. Cl. H01M 8/248; H01M 8/04746; H01M 8/2404; H01M 8/242

(52) U.S. Cl. CPC H01M 8/248; H01M 8/04776; H01M 8/2404; H01M 8/242

(57) ABSTRACT

An electric cell stack assembly is provided which includes at least an electric energy generating cell stack body with a plurality of unit cells stacked in a stacking direction, and at least one compression element configured to compress the cell stack body between a first and second endplate in the stacking direction, wherein the at least one compression element includes a band element having a first attaching element arranged at a first end, and a second attaching element arranged at a second end, wherein the first attaching element is an anchor bolt-like element protruding from the compression element perpendicular to the stacking direction, and the second attaching element is an anchor bolt-like element protruding from the compression element perpendicular to the stacking direction or a pressure adjusting element configured to adjust a pressure applied by the at least one compression element in the stacking direction.

### BACKGROUND AND SUMMARY

The present invention relates to an electric cell stack assembly.

Usually, an electric cell stack assembly, such as a fuel cell stack, comprises a stack body including a plurality of unit cells which are stack in a stacking direction. Each of the unit cells comprises at least two plates, so called flow field plates, which are placed on top of each other and have a flow field for the reactants at one side and a flow field for a cooling fluid on the other side. Thus, the flow fields of the adjacent plates form channels through which the respective fluids stream.

In order to avoid any fluid leaks and to achieve fluid tightness of the electric cell stack, the stack body is compressed in the stacking direction with the aid of a compression element. For example, the document KR101466507A1 describes a stack assembly in which the stack body is sandwiched between two end plates. Each of the end plates comprises an insertion groove having a recess on a side surface of the end plate and a fixing plate extending parallel to the outer peripheral surface of the end plate from the bottom surface of the insertion groove and protruding into the insertion groove. The compression of the stack assembly is obtained by inserting both ends of a fastening band, which extends along a side surface of the stack body, between the insertion groove of the end plate and the fixing plate, wherein each end of the fastening band is T-shaped. However, in order to insert the fastening band between the insertion groove of the end plate and the fixing plate, a stack compression is needed which exceeds the compression of the finished stack assembly. In other words, the stack body has to be more compressed during the assembly of the electric cell stack than during normal operation. Thus, there is a risk that parts of the electric cell stack assembly are damaged during the installation of the fastening band.

It is desirable to provide an electric cell stack assembly having an improved compression element for an electric cell stack assembly which reduces the risk of damaging the electric cell stack assembly during the installation of the compression element.

In the following an electric cell stack assembly, particularly fuel cell stack assembly, is provided which comprises at least an electric energy generating cell stack body with a plurality of unit cells stacked in a stacking direction, wherein preferably each unit cell is a unit fuel cell comprising a bipolar plate and a membrane electrode assembly. The stack assembly includes also a first and second endplate sandwiching the electric energy generating cell stack body, wherein at least one of the end plates has an opening in a side face, and at least one compression element configured to compress the cell stack body between the first and second end plate in the stacking direction.

The at least one compression element comprises a band element having a first end and a second end, wherein the at least one compression element comprises a first attaching element arranged at the first end, and a second attaching element arranged at the second end. The first attaching element is an anchor bolt-like element protruding from the compression element perpendicular to the stacking direction, and the second attaching element is an anchor bolt-like element protruding from the compression element perpendicular to the stacking direction or a pressure adjusting element configured to adjust a pressure applied by the at least one compression element in the stacking direction, wherein each anchor bolt-like element is formed integrally with or permanently fixed to the band element, wherein at least one anchor bolt-like element is inserted in the opening provided in the side face of the at least one end plate. This has the advantage that an over-compression of the stack assembly can be avoided during the assembly process. More particularly, the stack is compressed during the assembly process at most to a height of the finished stack assembly such that the attaching elements can be inserted into the corresponding openings in the endplate. Thus, the risk of damaging parts of the stack body is reduced. Moreover, since the at least one anchor bolt-like element is permanently fixed to or integrally formed with the band element a height of the stack assembly can be maintained over a life span of the stack assembly.

Preferably, the band element has a predetermined length. Preferably, the length is adapted to provide the desired pressure of the stack assembly under operation condition. This allows to determine the applied pressure in a case in which the first and second attaching elements are configured as anchor bolt-like elements without the risk to over compress the stack assembly. For example, the at least one compression element may be made of sheet metal. Preferably, the anchor bolt-like element may be welded, glued, and/or rivetted to the band element.

According to a further embodiment, the anchor bolt-like element and/or the pressure adjusting element has a bolt-like element, wherein the bolt-like element has a circular, rectangular, oval, triangular, or polygonal cross-section, and/or has a block, conical, frustoconical, or pyramidal shape, and/or has at least one chamfered edge. Preferably, the opening formed in the at least one end plate has a shape that is complementary to the bolt-like element. This has the advantage that a position of the bolt-like element can be defined within the opening. Furthermore, a contact area between the opening and the bolt-like element can be increased which can lead to an increased friction between the opening and the bolt-like element such that the position of the bolt-like element in the opening is secured.

Furthermore, the anchor bolt-like element comprises at least one position securing element configured to secure a position of the anchor bolt-like element. This reduces the risk that anchor bolt-like element disengages from the end plate due to vibrations and/or other external forces.

Preferably, the anchor bolt-like element includes a through hole, wherein a longitudinal axis of the through hole is perpendicular to the stacking direction, wherein the through hole is adapted to accommodate and/or interact with the position securing element. This allows to insert the position securing element through the through hole. For example, the position securing element may be permanently fixed in the opening of the end plate and the anchor bolt-like element may be fitted onto the position securing element and secured in this position with a suitable means such as a nut, glue, and/or welding. Alternatively, the position securing element can be inserted through the through hole in the anchor bolt-like element and secured in the end plate.

According to a further embodiment, the pressure adjusting element comprises a tensioning element which is adapted to apply a tension in a direction parallel to the stacking direction. Preferably, the tensioning element is further configured to continuously adjust the pressure applied in the stacking direction. Thus, the tensioning element allows to continuously increase and/or decrease the pressure applied to the electric cell stack assembly. Furthermore, the pressure adjusting element may include a through hole, wherein a longitudinal axis of the through hole is parallel to the stacking direction, wherein the through hole is adapted to accommodate and/or interact with the tensioning element.

Preferably, the position securing element and/or the tensioning element is a bolt or screw.

According to a further embodiment, the pressure adjusting element comprises a loop which is formed at the second end of the band element by folding the band element back on itself and fastening the folded end to the band element, wherein a bolt-like element having the through hole is fixed in the loop. For example, the folded end of the band element may be welded, screwed, bolted, rivetted and/or glued to the remaining band element. The bolt-like element may be arranged in the loop and secured to the band element. Furthermore, the band element may be provided with opening, such as a groove or an elongated hole, such that the bolt-like element is at least partially assessable after the bolt-like element is secured in the loop of the band element. For example, the bolt-like element may be welded, screwed, bolted, rivetted and/or glued to the loop.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

### BRIEF DESCRIPTION OF THE DRAWINGS

The figures show:

FIG. 1: a perspective view of a compression element according to a first embodiment,

FIG. 2: an exploded side view of an electric cell stack assembly with the compression element of FIG. 1,

FIG. 3: a perspective view of a compression element according to a second embodiment, and

FIG. 4: an exploded side view of an electric cell stack assembly with the compression element of FIG. 3.

### DETAILED DESCRIPTION

In the following same or similar functioning elements are indicated with the same reference numerals.

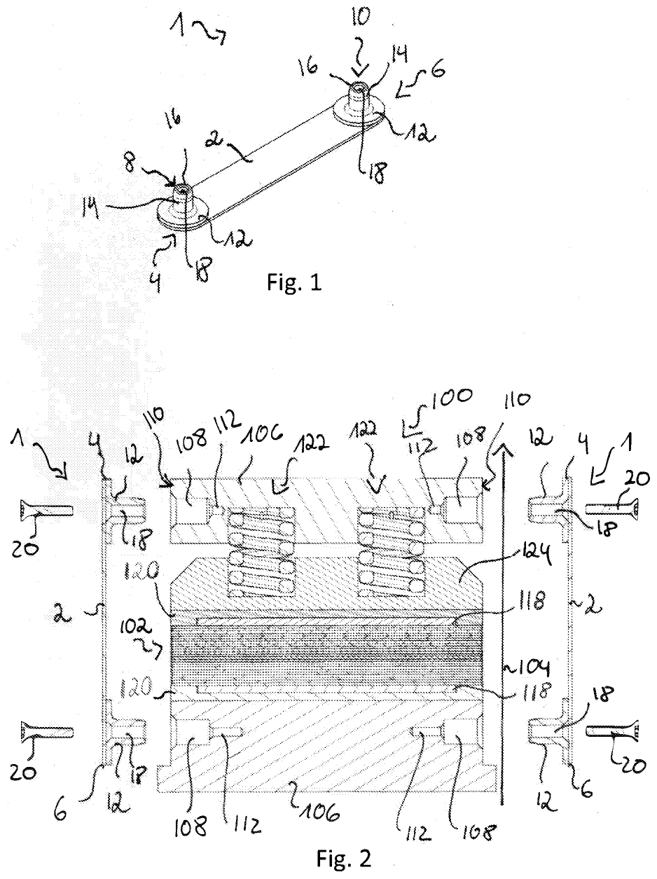

FIG. 1 shows a compression element 1 according to a first embodiment. The compression element 1 has a band element 2 with a first end 4 and a second end 6. First and second attaching elements 8, 10 are arranged at the first end and second end 4, 6, respectively. In FIG. 1, both attaching elements 8, 10 are anchor bolt-like elements 12 protruding from the compression element 1 perpendicular to longitudinal direction of the band element 2. As can be seen from FIG. 2, the longitudinal direction of the band element 2 is parallel to a stacking direction 104 of an electric cell stack assembly 100, thus the anchor bolt-like elements 8, 10 protrude from the compression element 1 perpendicular to the stacking direction 104 when arranged at the electric cell stack assembly 100.

The band element 2 has a predetermined length and is made of sheet metal. Each anchor bolt-like element 12 is permanently fixed to the band element by welding and is configured to be inserted in an opening (FIG. 2) provided in a side face of the electric cell stack assembly 100. However, the anchor bolt-like element 12 may also be glued and/or rivetted to the band element 2 or even formed integrally with the band element 2, for example in a casting process.

The anchor bolt-like element 12 includes a bolt-like element 14 that has a cylindrical shape with a chamfered top edge 16. Alternatively, the bolt-like element 14 may have any other suitable shape that can be inserted into an opening. For example, the bolt-like element 14 may have a circular, rectangular, oval, triangular, or polygonal cross-section, and/or may have a block, conical, frustoconical, or pyramidal shape.

FIG. 2 shows an exploded side view of the electric cell stack assembly 100. The electric cell stack assembly 100 may be a fuel cell stack assembly. As can be seen in FIG. 2, the electric cell stack assembly 100 comprises an electric energy generating cell stack body 102 with a plurality of unit cells stacked in a stacking direction 104. The stack assembly 102 includes also a first and second end plate 106 sandwiching the electric energy generating cell stack body 102. The electric energy generating cell stack body 102 is sandwiched between two terminal plates 118, which are insulated from the end plates 106 by two insulation plates 120.

In FIG. 2, both end plates 106 have an opening 108 in each of the side faces 110 that have a normal vector which is perpendicular to the stacking direction 104. The opening 108 has a shape that is complementary to the bolt-like element 14. This has the advantage that the attaching elements 8, 10 that a contact area between the bolt-like element 14 and the opening 108 is increased.

When the stack assembly 100 is assembled, the stack is compressed to a predetermined height and the bolt-like elements 14 of the attaching elements 8, 10 are then inserted into the corresponding openings 108 in the endplate 106. In order to account for any deviations in the dimensions of the stack assembly 100 components, for example due to manufacturing tolerances, the stack assembly 100 further includes two spring elements 122 and a compression plate 124. The compression plate 124 is arranged between the upper insulation plate 114 and the upper end plate 106, wherein the spring elements are disposed between the compression plate 124 and the end plate 106. Because each anchor bolt-like element 12 is permanently fixed to the band element 2 by welding, the position of the attaching elements 8, 10 is fixed such that the compression and therefore the height of the stack is retained over the lifetime of the stack assembly 100.

In order to secure the position of the attaching elements 8, 10, both anchor bolt-like elements 12 comprise through holes 18 through which a screw 20 is inserted which is screwed into a thread 112 provided in the openings 108 of the end plate 106. Thus, the through hole 18, the screw 20 and the thread 112 form a position securing element which is configured to secure a position of the attaching elements 8, 10. Alternatively, the position securing element may be a bolt that is permanently fixed in the opening 108 of the end plate 106 and the anchor bolt-like element 12 may be fitted onto the position securing element and secured in this position with a suitable means such as a nut, glue, and/or welding.

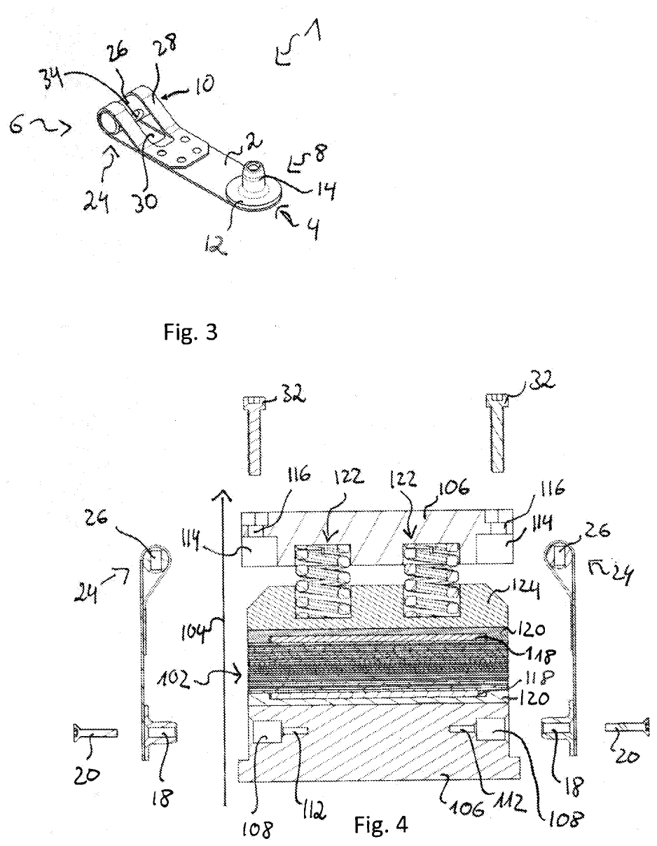

FIG. 3 shows a compression element 1 according to a second embodiment. The compression element has a band element 2 with a first end 4 and a second end 6. A first and second attaching element 8, 10 are arranged at the first end and second end, respectively. In FIG. 3, the first attaching element 8 is an anchor bolt-like element 12 as described above. The second attaching element 10 is a pressure adjusting element 24 being configured to adjust a pressure applied by the compression element 1 in the stacking direction 104 (FIG. 4).

The pressure adjusting element 24 has a bolt-like element 26 having a cylindrical shape. Alternatively, the bolt-like element 26 may have any other suitable shape. For example, the bolt-like element 26 may have a circular, rectangular, oval, triangular, or polygonal cross-section, and/or may have a block, conical, frustoconical, or pyramidal shape, and/or has at least one chamfered edge. Furthermore, the pressure adjusting element 24 comprises a loop 28 which is formed at the second end 6 of the compression element 1 by folding the band element 2 back on itself and fastening the folded end to the band element 2. For example, the folded end may be welded, screwed, bolted, rivetted and/or glued. The bolt-like element 26 is arranged in the loop 28 and secured to the band element 2 by welding. In this case, the band element 2 is provided with an elongated hole 30 such that the bolt-like element 26 is at least partially assessable after the bolt-like element 28 is welded to the band element 2.

FIG. 4 shows an exploded side view of an electric cell stack assembly 100. The electric cell stack assembly 100 may be a fuel cell stack assembly. As can be seen in FIG. 4, the electric cell stack assembly 100 comprises an electric energy generating cell stack body 102 with a plurality of unit cells stacked in a stacking direction 104. The stack assembly 102 includes also a first and second endplate 106 sandwiching the electric energy generating cell stack body 102. The electric energy generating cell stack body 102 is sandwiched between two terminal plates 118, which are insulated from the end plates 106 by two insulation plates 120. In order to account for any deviations in the dimensions of the stack assembly 100 components, for example due to manufacturing tolerances, the stack assembly 100 further includes two spring elements 122 and a compression plate 124. The compression plate 124 is arranged between the upper insulation plate 114 and the upper end plate 106, wherein the spring elements are disposed between the compression plate 124 and the end plate 106.

As can be seen in FIG. 4, one of the end plates 106 has an opening 108 as described above which has a shape that is complementary to the bolt-like element 14 of the first attaching element 8. The other end plate 106 has an opening 114 that is suitable the receive the pressure adjusting element 24 of the second attaching element 10. Furthermore, the other end plate 106 includes a though hole 116 through which a tensioning element 32 such as a screw or bolt can be inserted that is configured to cooperated with a hole 34 in the bolt-like element 26.

When the stack assembly 100 is assembled, the first attaching element 8 having the anchor bolt-like element 12 is inserted into the corresponding opening 108. The other end can then be aligned with the opening 114 in the other endplate 106 and the tensioning element 32 can then be tightened with an appropriate torque such that the pressure applied to the stack 100 is adjustable, while still maintaining a certain amount of rigidness.

The tensioning element 32 is adapted to apply a tension in a direction parallel to the stacking direction 104. By tightening and/or loosening the tensioning element 32, the pressure applied by the compression element 1 in the stacking direction 104 can be continuously adjusted. Thus, the tensioning element 32 allows to continuously increase and/or decrease the pressure applied to the electric cell stack assembly 100. The hole 34 may be configured as a through hole, wherein a longitudinal axis of the through hole is parallel to the stacking direction 104.

In summary, the described compression element provides a compression retention that can be maintain through the lifespan of the electric cell stack assembly. More particularly, the embodiment having two anchor bolt-like elements may provide as much rigidity as threaded rods, while using significantly less space and weight. Furthermore, since the length is completely determined in advance, the risk of tilting, force imbalances and/or other assembly related issues is eliminated or at least reduced. Moreover, the embodiment having a pressure adjusting element provides enough rigidity, while still being adjustable to account for variations in cell stack height.

Both described embodiments have the advantage that the compression element s are only arranged on the sides of the electric cell stack assembly such that the surfaces on the top and bottom of the electric cell stack assembly are free and may be used for other features.

### REFERENCE NUMERALS

1 compression element
2 band element
4 first end
6 second end
8 first attaching element
10 second attaching element
12 anchor bolt-like element
14 bolt-like element
16 top edge
18 through hole
20 position securing element
24 pressure adjusting element
26 bolt-like element
28 loop
30 elongated hole
32 tensioning element
34 through hole
100 electric cell stack assembly
102 electric energy generating cell stack body
104 stacking direction
106 end plate
108 opening
110 side face
112 thread
114 opening
116 through hole
118 terminal plate
120 insulation plate
122 spring element
124 compression plate

1. Electric cell stack assembly, comprising at least
an electric energy generating cell stack body with a plurality of unit cells stacked in a stacking direction,
a first and second endplate sandwiching the electric energy generating cell stack body, wherein at least one of the end plates has an opening in a side face, and
at least one compression element configured to compress the electric energy generating cell stack body between the first and second endplate in the stacking direction,
wherein
the at least one compression element comprises a band element having a first end and a second end, wherein the at least one compression element comprises a first attaching element arranged at the first end, and a second attaching element arranged at the second end, wherein the first attaching element is an anchor bolt-like element protruding from the compression element perpendicular to the stacking direction, and the second attaching element is an anchor bolt-like element protruding from the compression element perpendicular to the stacking direction or a pressure adjusting element configured to adjust a pressure applied by the at least one compression element in the stacking direction, wherein each anchor bolt-like element is formed integrally with or permanently fixed to the band element, wherein at least one anchor bolt-like element is inserted in the opening (108) provided in the side face of the at least one end plate.

2. Electric cell stack assembly according to claim 1, wherein the band element has a predetermined length.

3. Electric cell stack assembly according to claim 1, wherein the anchor bolt-like element and/or the pressure adjusting element has a bolt-like element, wherein the bolt-like element has a circular, rectangular, oval, triangular, or polygonal cross-section, and/or has a block, conical, frustoconical, or pyramidal shape, and/or has at least one chamfered edge.

4. Electric cell stack assembly according to claim 3, wherein the opening formed in the at least one end plate has a shape that is complementary to the bolt-like element.

5. Electric cell stack assembly according to claim 1, wherein the anchor bolt-like element comprises at least one position securing element configured to secure a position of the attaching element in the opening.

6. Electric cell stack assembly according to claim 5, wherein the anchor bolt-like element includes a through hole, wherein a longitudinal axis of the through hole is perpendicular to the stacking direction, wherein the through hole is adapted to accommodate and/or interact with the position securing element.

7. Electric cell stack assembly according to claim 1, wherein the pressure adjusting element comprises a tensioning element which is adapted to apply a tension in a direction parallel to the stacking direction.

8. Electric cell stack assembly according to claim 7, wherein the pressure adjusting element includes a through hole, wherein a longitudinal axis of the through hole is parallel to the stacking direction, wherein the through hole is adapted to accommodate and/or interact with the tensioning element.

9. Electric cell stack assembly according to claim 8, wherein the pressure adjusting element comprises a loop (28) which is formed at the second end of the band element by folding the band element back on itself and fastening the folded end to the band element, wherein a bolt-like element having the through hole is fixed in the loop (28).

10. Electric cell stack assembly according to claim 5, wherein the position securing element and/or the tensioning element is a bolt or screw.

11. Electric cell stack assembly according to claim 1, wherein the at least one compression element is made of sheet metal.
